(19) United States
(12) Patent Application Publication
(10) Pub. No.: US 2019/0272585 A1
(43) Pub. Date: Sep. 5, 2019

(54) VIRTUAL SHOPPING SOFTWARE SYSTEM AND METHOD

(71) Applicant: Misho MILICEVIC, Port Coquitlam (CA)

(72) Inventor: Misho MILICEVIC, Port Coquitlam (CA)

(21) Appl. No.: 16/348,464

(22) PCT Filed: Nov. 8, 2017
(86) PCT No.: PCT/CA2017/051332

§ 371 Date: May 8, 2019

Related U.S. Application Data
(60) Provisional application No. 62/419,301, filed on Nov. 8, 2016.

(51) Int. Cl. G06Q 30/06; G06N 20/00; G06T 13/40; G06T 19/00

(52) U.S. Cl. CPC G06Q 30/0643; G06T 19/00; G06T 13/40; G06N 20/00

(57) ABSTRACT

A virtual shopping software system and method; the method includes providing a virtual shopping software system having a computing device hosting an application and in communication with a product supplier via a communication network, and a database coupled to the computing device and storing therein at least one product selection. The virtual shopping software system and method may generate a 3D shopping experience.

### CROSS REFERENCE TO RELATED APPLICATION

The present application is related to and claims priority to U.S. Provisional Patent Application No. 62/419,301 filed 2016 Nov. 8, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### FIELD OF THE INVENTION

The present invention relates generally to the field of online shopping and more specifically relates to virtual shopping.

### DESCRIPTION OF RELATED ART

Online shopping or ecommerce has drastically increased as a form of consumer shopping. Online shopping allows consumers to directly buy goods or services from a seller over the Internet. Consumers find a product of interest by visiting the website of the retailer directly or by searching among alternative vendors using a search engine. There are apparent benefits of online shopping including no wait “time” required for shopping, better size selection/availability, but has the drawback that one cannot try on the article of clothing or accessory and see what it looks like on the shopper. Furthermore, consumers miss out on the “shopping” experience of socializing with other consumers or retailers. Therefore, a suitable solution is desired.

U.S. Pub. No. 2014/0108208 to Andrea Piana relates to a personalized virtual shopping assistant. The described personalized virtual shopping assistant includes a personalized virtual shopping assistant system and method which includes a plurality of individualized avatars which can be used by shoppers to see how various articles of clothing or accessories would look on themselves. The individualized avatars are created from a 3D body scan of all or a portion of the shopper to create an avatar which accurately reflects the size and shape of the shopper. When performing online shopping, the shopper retrieves his or her avatar for display on a display screen of a smartphone, tablet, computer, kiosk, or other device or system, and places computer representations of articles of clothing or accessories on the avatar. The computer representations are provided by the manufacturers or retailers or other sources. In some configurations, the computer representations may be manipulated to shrink or expand to fit the avatar. The personalized virtual shopping assistant system and method permits the shopper to “see” how a particular product or group of products “looks” on their body since they will be presented with the item(s) on an avatar of themselves.

### BRIEF SUMMARY OF THE INVENTION

In view of the foregoing disadvantages inherent in the known online shopping art, the present disclosure provides a novel virtual shopping software system and method. The general purpose of the present disclosure, which will be described subsequently in greater detail, is to provide a software platform for use with a computing device (i.e. mobile phone or desktop). The software may facilitate the growing transition towards online accessibility for consumer retail clothing and accessory markets. The software may include a virtual, three-dimensional shopping experience.

A virtual shopping software system and method is disclosed herein. The virtual shopping software system and method includes providing a virtual shopping software system. The virtual shopping software system comprises a computing device hosting an application and in communication with a product supplier via a communication network. A database may be coupled to the computing device and storing therein at least one product selection. The virtual shopping software system may generate a three-dimensional (3D) store environment representing a bricks-and-mortar store. The product supplier may remotely upload the at least one product selection from the database to the three-dimensional (3D) store environment via the communication network.

The virtual shopping software system and method may further include a method of registering a user, generating an avatar representing the user via a camera coupled to the computing device, selecting the at least one product selection from the three-dimensional (3D) store environment, displaying the at least one product selection on the avatar, and purchasing the at least one product selection.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a virtual shopping software system and method, constructed and operative according to the teachings of the present disclosure.

FIG. 1 is a front view of the virtual shopping software system and method during an ‘in-use’ condition, according to an embodiment of the disclosure.

FIG. 2 is a front view of the virtual shopping software system and method of FIG. 1, according to an embodiment of the present disclosure.

FIG. 3 is a front view of the virtual shopping software system and method of FIG. 1, according to an embodiment of the present disclosure.

FIG. 4 is a front view of the virtual shopping software system and method of FIG. 1, according to an embodiment of the present disclosure.

FIG. 5 is a front view of the virtual shopping software system and method of FIG. 1, according to an embodiment of the present disclosure.

FIG. 6 is a front view of the virtual shopping software system and method of FIG. 1, according to an embodiment of the present disclosure.

FIG. 7 is a front view of the virtual shopping software system and method of FIG. 1, according to an embodiment of the present disclosure.

FIG. 8 is a front view of the virtual shopping software system and method of FIG. 1, according to an embodiment of the present disclosure.

FIG. 9 is a front view of the virtual shopping software system and method of FIG. 1, according to an embodiment of the present disclosure.

FIG. 10 is a front view of the virtual shopping software system and method of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to online shopping and more particularly to a virtual shopping software system and method as used to improve the efficiency and effectiveness of virtual shopping for both consumers and retailers.

Generally, the present disclosure provides a fully encompassing and strategically assembled software platform that can solve almost every problem or issue facing consumers and retailers alike in the online apparel markets, creating a synergy of the market to consumer relationship. With the present disclosure, users will finally have peace of mind with the ability to try on apparel and accessories using a three-dimensional (3D) anatomical avatar replica of themselves that works in coordination with a catalog, a scrapbook, a virtual-wardrobe, a social media sharing tool, and accurate 3D representations of apparel and accessory items supplied from a database to the product suppliers. The anatomical representations, modeled in 3D, can be generated through various methods, including but not limited to: images or video captured by the user's computing device, where algorithms are used to extract dimensional data from images captured and obtaining measurements direct from the user. The 3D shopping environment gives users the ability to shop in the same way they would in a shopping mall, with all the realism of brick and mortar stores.

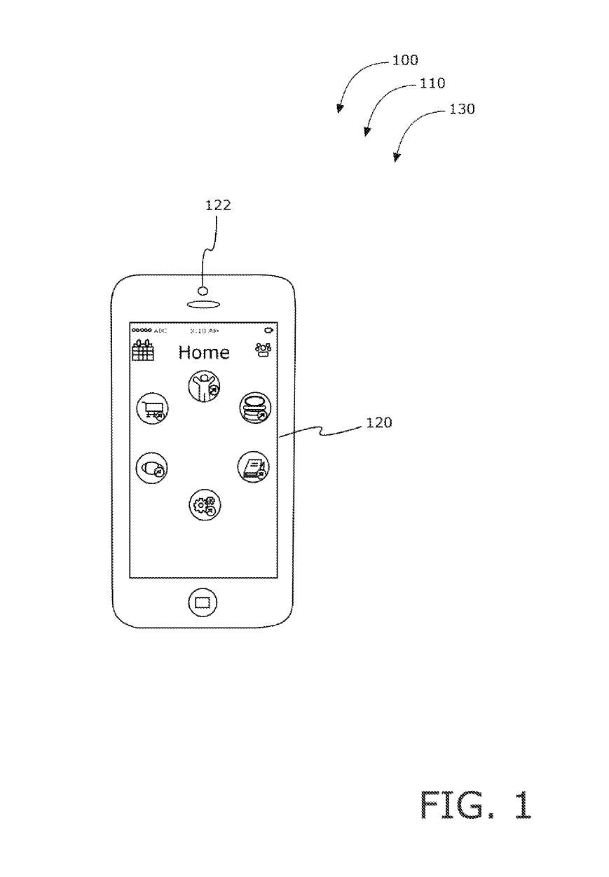

Referring now more specifically to the drawings by numerals of reference, there is shown in FIGS. 1-10, various views of a virtual shopping software system and method 100 according to an embodiment of the present disclosure. FIG. 1 shows a front view of the virtual shopping software system and method 100, according to an embodiment of the present disclosure. The virtual shopping software system and method 100 may include a method of providing a virtual shopping software system 100. The virtual shopping software system 100 may comprise a computing device 110 hosting an application and in communication with a product supplier via a communication network, and a database that may be coupled to the computing device 110 and storing therein at least one product selection. The virtual shopping software system 100 may generate a three-dimensional (3D) store environment representing 140 a bricks-and-mortar store. The product supplier may remotely upload the at least one product selection from the database to the three-dimensional (3D) store environment 140 via the communication network, and/or to a catalog 136.

The virtual shopping software system and method 100 may further include registering a user, generating an avatar representing the user via a camera 122 coupled to the computing device 110, communicating with user(s) on the virtual shopping software system 100, selecting the at least one product selection from the three-dimensional (3D) store environment 140, displaying the at least one product selection on the avatar, and purchasing the at least one product selection.

The virtual shopping software system and method 100 may include means for advertising the at least one product selection to user(s) and logging events and activity of the user on the database. Further, the virtual shopping software system and method 100 may provide capacity to communicate with a product supplier billing for purchasing the at least one product selection. All the steps associated with the virtual shopping software system and method 100 may be performed remotely via a wireless connection (i.e. Internet).

The virtual shopping software system and method 100 may further comprise a plurality of artificial-intelligence-items. The plurality of artificial-intelligence-items may include behavioral learning, database mapping, object recognition, statistical learning, comparisons, coordinate system mapping, etc. The plurality of artificial-intelligence-items may be integrated to achieve extrapolating data, run algorithms, calculate dimensions, changing body sizes, etc. that may allow features of the present disclosure to be capable. The plurality of artificial-intelligence-items may additionally provide a structured marketing analytics for the product suppliers.

An interface 120 may be communicably coupled to the computing device 110. The interface 120 may include but not limited to a scrapbook 138, a virtual-fitting-room 132, a virtual-wardrobe 134, the three-dimensional (3D) store environment 140, a calendar, the catalog 136, and a shopping-cart. As illustrated in FIG. 1, a home screen 130 may be included with the interface 120. The home screen 130 may include access to the three-dimensional (3D) store environment 140, the virtual-fitting-room 132, the virtual-wardrobe 134, the catalog 136, the scrapbook 138, the calendar, and settings associated with the application. The home screen 130 may also showcase the advertising of the at least one product selection. Advertising may include desired advertisement designated from the product supplier and from the preferences of the user. Preferences of the user may be recorded to the database by logging events and activity of the user.

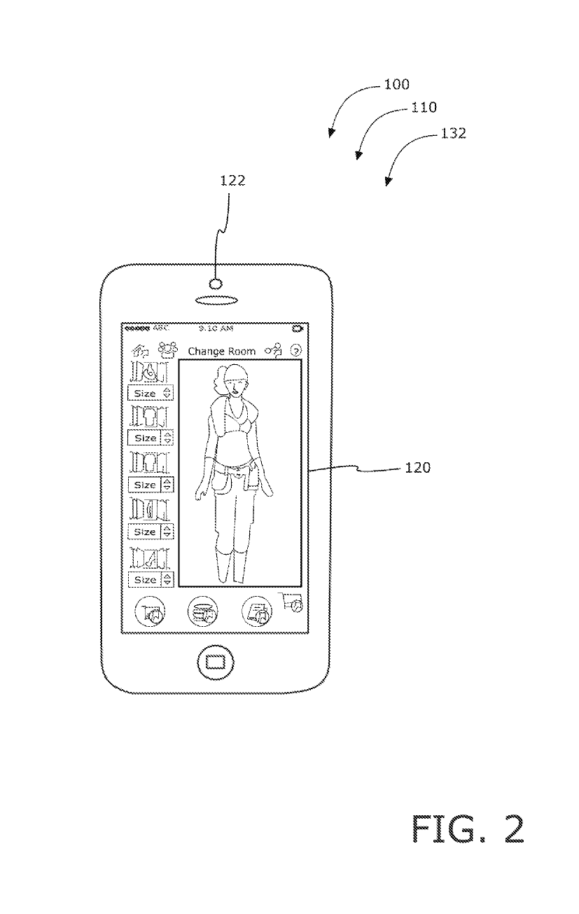

FIG. 2 shows a front view of the virtual shopping software system and method 100 of FIG. 1, according to an embodiment of the present disclosure. As above, the virtual shopping software system and method 100 may include the interface 120 communicably coupled to the computing device 110 and having the virtual-fitting-room 132. The virtual-fitting-room 132 may allow displaying the at least one product selection on the avatar. Displaying the at least one product selection on the avatar may include dragging and dropping the at least one product selection to the avatar. The avatar may be rotated in any direction. In addition, the user may have the ability to move body parts associated with the avatar. Snapshots of the avatar may be taken and shared with other user(s) and social media/email sharing tools or saved to the scrapbook 138.

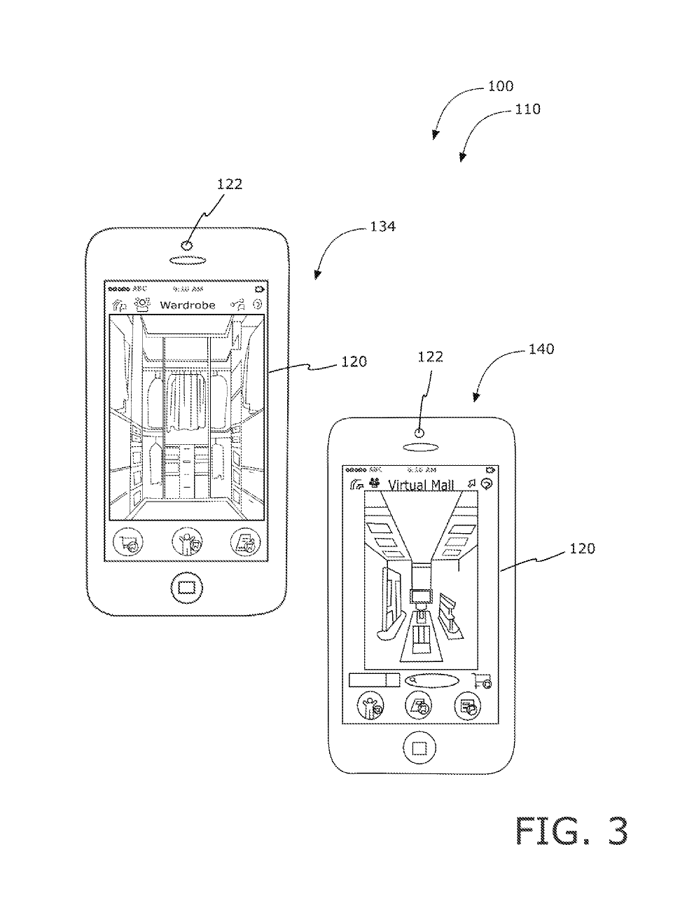

FIG. 3 shows a front view of the virtual shopping software system and method 100 of FIG. 1, according to an embodiment of the present disclosure. As above, the virtual shopping software system and method 100 may include the interface 120 communicably coupled to the computing device 110 and having the virtual-wardrobe 134. Purchasing the at least one product selection may add the at least one product selection to the virtual-wardrobe 134. The user may take the at least one product selection from the virtual-wardrobe 134 to the virtual-fitting-room 132, the scrapbook 138, or utilize the social media/email sharing tools. Additionally, the virtual-wardrobe 134 may be accessed from the three-dimensional (3D) store environment 140 or the catalog 136. The virtual-wardrobe 134 may provide the user with the ability to use the at least one product selection purchased prior with new ones purchased recently.

The three-dimensional (3D) store environment 140 may represent the bricks-and-mortar store, the mall, or other store environments. The three-dimensional (3D) store environment 140 may be customized and include a variety of design layouts. The product suppliers may design the three-dimensional (3D) store environment 140 based on geographic regions or demographics.

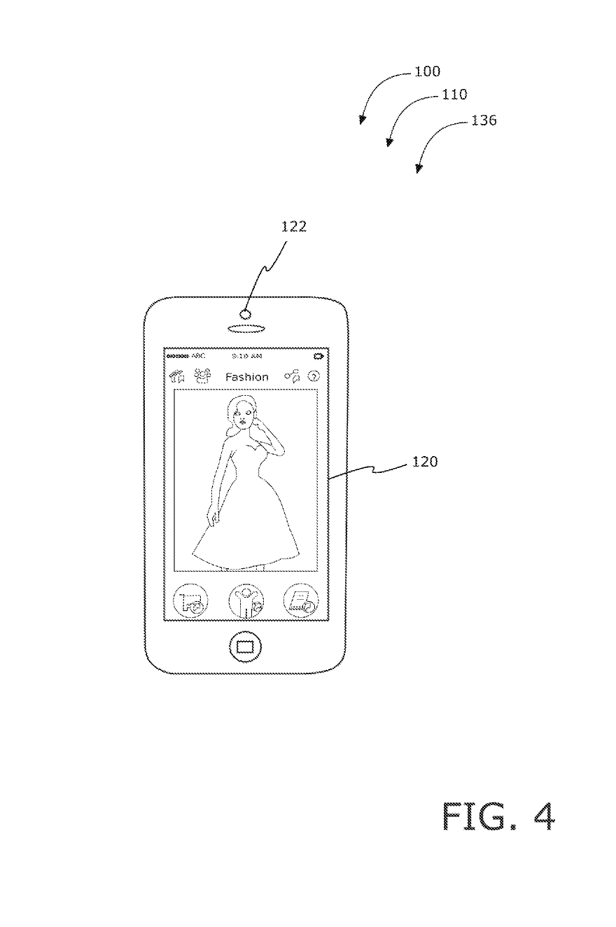

FIG. 4 shows a front view of the virtual shopping software system and method 100 of FIG. 1, according to an embodiment of the present disclosure. As above, the virtual shopping software system and method 100 may include the interface 120 communicably coupled to the computing device 110 and having the catalog 136. The catalog 136 may display existing or custom designed fashion magazines into computerized versions. The user may utilize the catalog 136 when shopping for the at least one product selection. In addition, the user may select the at least one product selection from the catalog 136, and drag and drop them to the virtual-fitting-room 132, the scrapbook 138 or shared with other user(s) with the social media/email sharing tools. The catalog 136 may represent fashion magazines, or other custom catalogs.

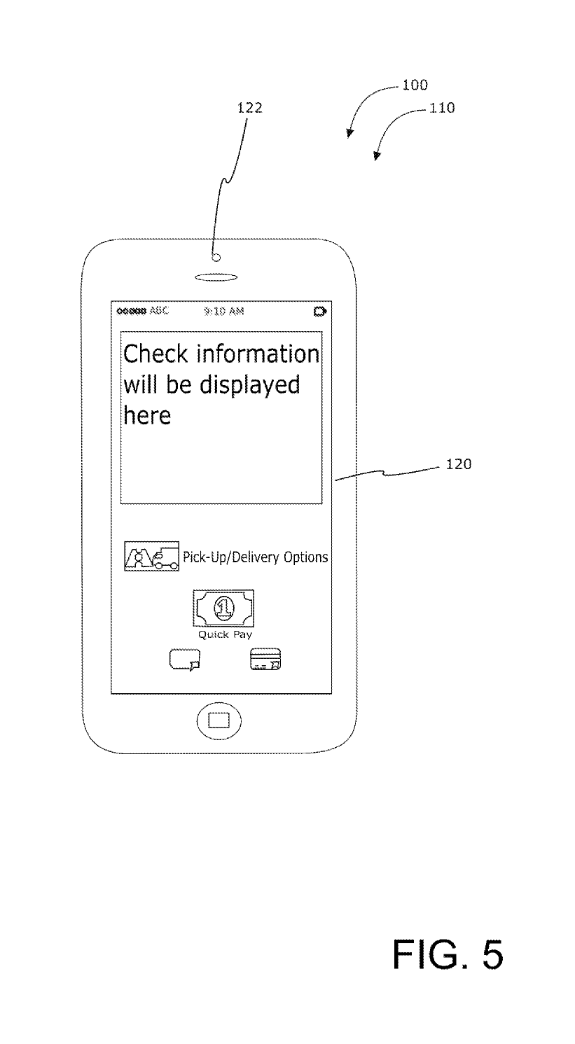

FIG. 5 shows a front view of the virtual shopping software system and method 100 of FIG. 1, according to an embodiment of the present disclosure. As above, the virtual shopping software system and method 100 may provide the capacity to communicate with the product supplier billing for purchasing the at least one product selection. Additionally, the user may have the capacity to choose if they want the at least one product selection to be picked-up/delivered. Further customization may include providing real-time inventory data to the user of nearby product suppliers with the at least one product selection in stock.

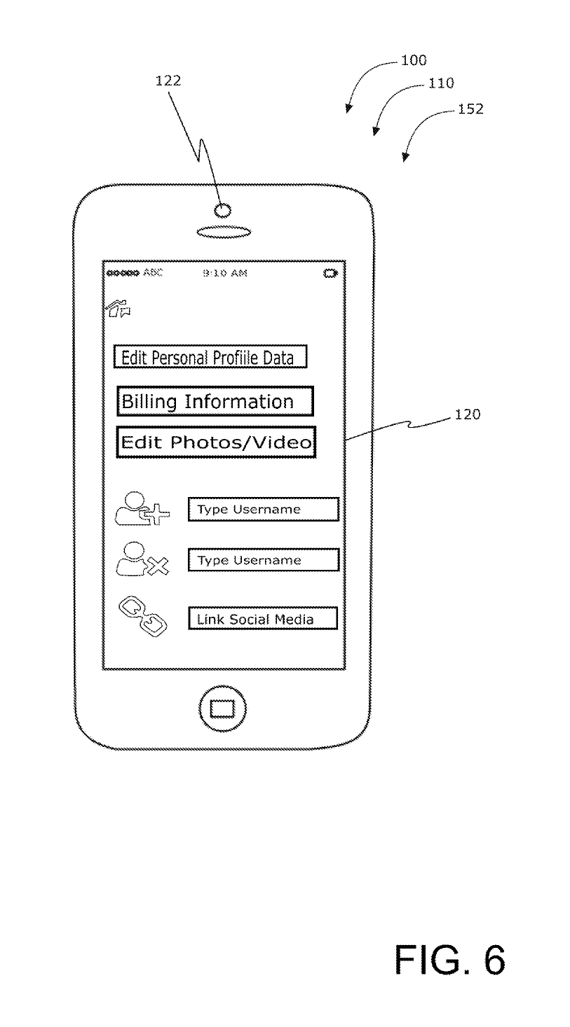

FIG. 6 shows a front view of the virtual shopping software system and method 100 of FIG. 1, according to an embodiment of the present disclosure. As stated above, the virtual shopping software system and method 100 may include the step of registering the user. A profile 152 may be associated with registering the user. The profile 152 may store a plurality of user-information and the social media/email sharing tools. Additionally, the profile 152 may invite other users to shop for them (permitting other users to use their avatar) or ask other users for permission to use their avatar.

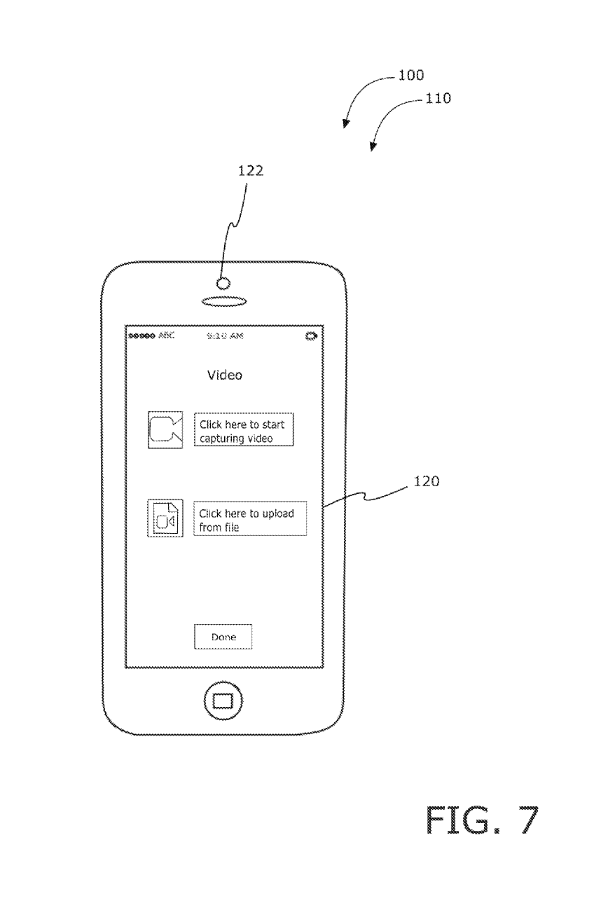

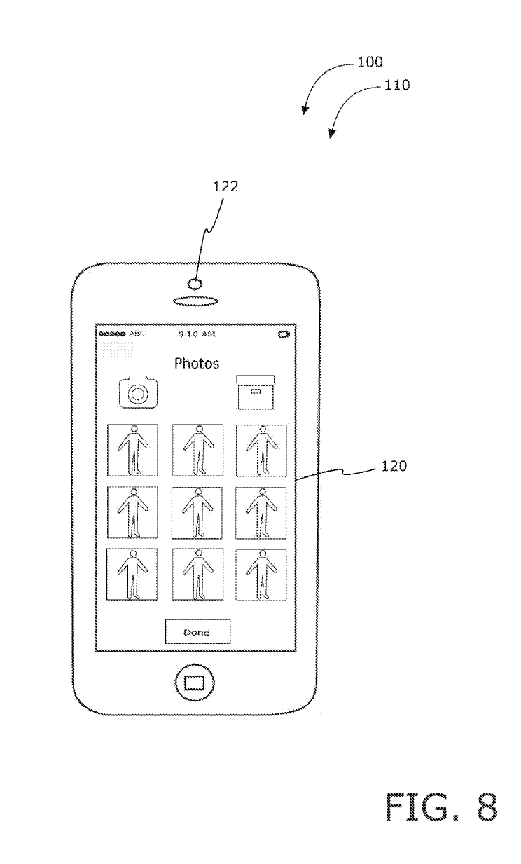

FIGS. 7-8 show front views of the virtual shopping software system and method 100 of FIG. 1, according to an embodiment of the present disclosure. As above, the virtual shopping software system and method 100 may include the method of generating the avatar representing the user via the camera 122 coupled to the computing device 110. Generating the avatar may include the steps of extrapolating data from two-dimensional (2D) images and videos taken via the camera 122, processing size-dimensions of the two-dimensional (2D) images and videos, and obtaining a three-dimensional representation of the avatar. Generating the avatar, in conjunction with measurements obtained for the at least one product selection, may enable the user to automatically have the correct sized apparel. The two-dimensional (2D) images and videos may comprise approximately 3 to 6 images and 1 video. However, as technology advances, and as the plurality of artificial-intelligence-items collects more anthropomorphic data, adjustments to the number of images and videos needed may change. Moreover, the two-dimensional (2D) images and videos may include different positions of the user to accurately generate the avatar.

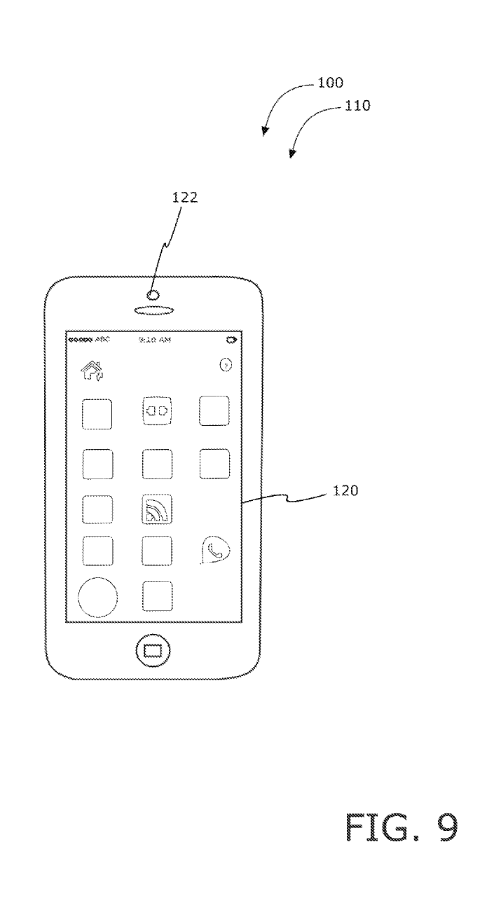

FIG. 9 shows a front view of the virtual shopping software system and method 100 of FIG. 1, according to an embodiment of the present disclosure. As above, the virtual shopping software system and method 100 may further include communicating with user(s). Communicating with user(s) may include sending invites to share with the user(s), shop for user(s), or allow user(s) to shop for the current user (i.e. “Shop-For-Friends”). Further, sharing with the user(s) may include the social media/email sharing tools. The social media/email sharing tools may provide the user the ability to collect items they wish to share, sort and organize these items here, then delegate which groups of items they wish to share with which the social media/email tools by selecting corresponding icons and grouped items, and then sending to all destinations desired.

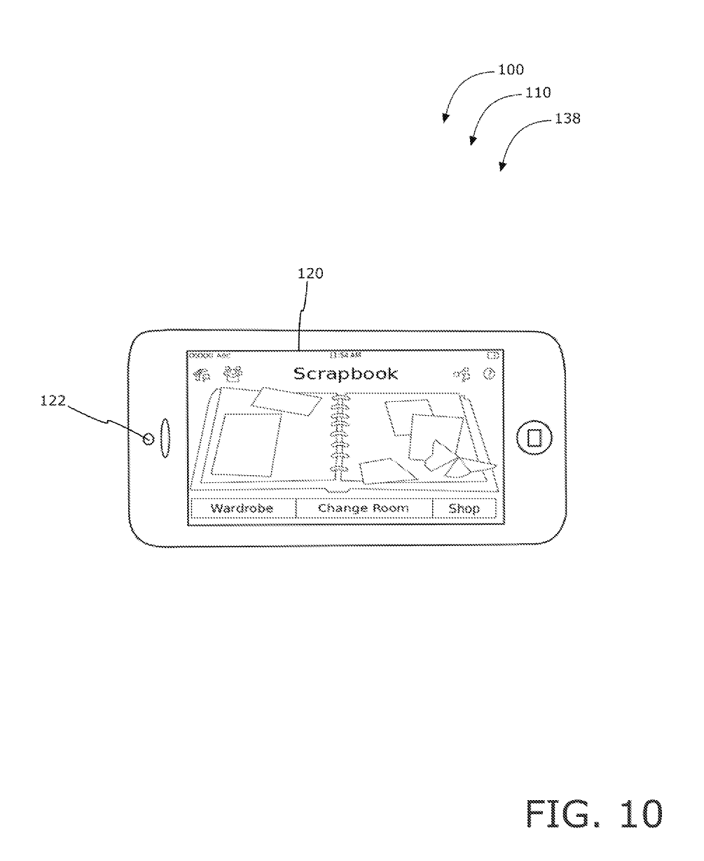

FIG. 10 shows a front view of the virtual shopping software system and method 100 of FIG. 1, according to an embodiment of the present disclosure. As above, the virtual shopping software system and method 100 may include the interface 120 communicably coupled to the computing device 110. The interface 120 may include the scrapbook 138. The scrapbook 138 may allow the users to scrapbook the at least one product selection for any reason and in any fashion. Primarily users may paste images of the at least one product selection, either wearing it on the avatar or not, as desired in the scrapbook 138. Default categories of the scrapbook 138 may include a wish list and past/future events. Users may have the option to create their own categories in the scrapbook 138. The scrapbook 138 may include access to the virtual-fitting-room 132, the virtual-wardrobe 134, the catalog 136, the calendar, etc.

Upon reading this specification, it should be appreciated that, under appropriate circumstances, considering such issues as user preferences, design preference, structural requirements, marketing preferences, cost, available materials, technological advances, etc., other virtual shopping software system and method 100 arrangements such as, for example, the interface 120, generating the avatar, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A virtual shopping software system and method of generating a 3D shopping experience, the method comprising:
providing a virtual shopping software system, comprising:
a computing device hosting an application and in communication with a product supplier via a communication network;
a database coupled to said computing device and storing therein at least one product selection;
wherein said virtual shopping software system generates a three-dimensional (3D) store environment representing a bricks-and-mortar store; and
wherein said product supplier remotely uploads said at least one product selection from said database to said three-dimensional (3D) store environment via said communication network;
registering a user;
generating an avatar representing said user via a camera coupled to said computing device;
selecting said at least one product selection from said three-dimensional (3D) store environment;
displaying said at least one product selection on the avatar; and
purchasing said at least one product selection.

2. The method of claim 1, further comprising communicating with user(s) on said virtual shopping software system.

3. The method of claim 2, wherein said communicating includes sending invites to said user(s).

4. The method of claim 1, wherein generating said avatar includes the steps of
extrapolating data from two-dimensional (2D) images and videos taken via said camera,
processing size-measurements of said two-dimensional (2D) images and videos,
obtaining a three-dimensional representation of said avatar.

5. The method of claim 4, wherein said two-dimensional (2D) images and videos comprises approximately 3 to 6 images and 1 video.

6. The method of claim 1, further comprising advertising said at least one product selection.

7. The method of claim 1, further comprising logging events and activity of said user on said database.

8. The method of claim 1, wherein said virtual shopping software system provides capacity to communicate with a product supplier billing.

9. The method of claim 1, wherein the steps are performed remotely via a wireless connection.

10. A virtual shopping software system comprising:
a computing device hosting an application and in communication with a product supplier via a communication network;
a database coupled to said computing device and storing therein at least one product selection;
wherein said virtual shopping software system generates a three-dimensional (3D) store environment representing a bricks-and-mortar store; and
wherein said product supplier remotely uploads said at least one product selection from said database to said three-dimensional (3D) store environment via said communication network.

11. The virtual shopping software system and method of claim 10, further comprising an interface communicably coupled to said computing device.

12. The virtual shopping software system and method of claim 11, wherein said interface includes a scrapbook.

13. The virtual shopping software system and method of claim 11, wherein said interface includes a virtual-fitting-room.

14. The virtual shopping software system and method of claim 11, wherein said interface includes a virtual-wardrobe.

15. The virtual shopping software system and method of claim 11, wherein said interface includes a calendar.

16. The virtual shopping software system and method of claim 11, wherein said interface includes a catalog.

17. The virtual shopping software system and method of claim 11, wherein said interface includes a shopping-cart.

18. The virtual shopping software system and method of claim 10, further comprising a plurality of artificial-intelligence-items.

19. The virtual shopping software system and method of claim 18, wherein said plurality of artificial-intelligence-items includes behavioral learning, database mapping, and object recognition.

20. A virtual shopping software system and method of generating a 3D shopping experience, the method comprising:
providing a virtual shopping software system, comprising:
a computing device hosting an application and in communication with a product supplier via a communication network;
a database coupled to said computing device and storing therein at least one product selection;
wherein said virtual shopping software system generates a three-dimensional (3D) store environment representing a bricks-and-mortar store; and
wherein said product supplier remotely uploads said at least one product selection from said database to said three-dimensional (3D) store environment via said communication network;
registering a user;
generating an avatar representing said user via a camera coupled to said computing device;
advertising said at least one product selection;
communicating with users on said virtual shopping software system;
selecting said at least one product selection from said three-dimensional (3D) store environment;
displaying said at least one product selection on the avatar;
purchasing said at least one product selection; and
logging events and activity of said user on said database.
